(19) United States
(12) Patent Application Publication
(10) Pub. No.: US 2010/0051110 A1
(43) Pub. Date: Mar. 4, 2010

(54) GAS ACTUATED VALVE

(75) Inventor: Cham Ocondi, Aurora, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: CH2M Hill, Inc., Englewood, CO (US)

(21) Appl. No.: 12/552,630

(22) Filed: Sep. 2, 2009

Related U.S. Application Data
(60) Provisional application No. 61/094,274, filed on Sep. 4, 2008.
(60) Provisional application No. 61/094,485, filed on Sep. 5, 2008.

(51) Int. Cl. F16K 31/124

(52) U.S. Cl. 137/2; 137/486

(57) ABSTRACT

A method and system to pulse at least one solenoid valve to regulate the volume of instrument air or other gas (e.g. nitrogen or natural gas) to the supply side or from the discharge side of a diaphragm actuator. The diaphragm actuator operates a primary variable flow/choke control valve in response to process control signals.

### CROSS REFERENCE TO RELATED APPLICATIONS

This application is related to U.S. Provisional Patent Application No. 61/094,274, which was filed on Sep. 4, 2008 and titled “Gas Actuated Valve” (attorney docket no. 190477US). This application is also related to U.S. Provisional Patent Application No. 61/094,485, which was filed on Sep. 5, 2008 and titled “Gas Actuated Valve” (attorney docket no. 190477US2). This application claims priority to both of these applications and incorporates both of them by reference herein as if fully reproduced below.

### FIELD OF THE INVENTION

The present invention relates to a gas actuated valve system. More particularly, the present invention relates to a gas actuated valve system having inlet and outlet containment valves for controlling the position of the actuated primary valve.

### BACKGROUND OF THE INVENTION

Some Industrial flow control systems commonly found in processing plants, manufacturing plants and field production facilities utilize various types of automated control valves to control the flow of fluids in piping systems over a wide range of pipe sizes and flow rates. A typical automated flow control system consists of a programmable device such as a programmable logic controller (PLC) or remote terminal unit (RTU) in communication with an automated flow/choke control valve to automatically open, close or modulate the valve opening to control the flow of fluids through the valve in response to process control signals. An electro-pneumatic diaphragm actuator or an electric motor actuator mounted on the stem of the control valve body provides the motive force to vary the valve open/close position.

Processing plants and manufacturing plants commonly have economically available and reliable sources of instrument air and AC power for operating pneumatic and/or electric motor actuators for opening or closing control valves.

For an installation with an electro-pneumatic diaphragm actuator, a PLC or RTU utilizes an electrical current of approximately 4-20 milliamps (ma) to control a pressure regulator, in response to the changing process conditions, to regulate the flow of instrument air or other gas supplied to the pneumatic diaphragm actuator. This system typically requires a continuous supply of electrical power and instrument air or other gas to keep the valve at the desired position and actuate it to new positions. A typical PLC or RTU requires approximately 3.6 Watts of power (300 ma @12V) to drive the pressure regulator. The pneumatic actuator constantly vents approximately 100 cu. feet of air or gas daily.

For an installation with an electric motor actuator, the PLC or RTU regulates the time that current is directly applied to a reversible electric motor. The system requires approximately 24 Watts of power (2 amps @12V) to drive the valve from a fully closed to a fully open position. This transition from fully closed to fully open may take up to a minute.

Remote oil and gas field production facilities, where these types of installations may be installed, typically do not have an economically available source of either instrument air or AC power. These facilities often need to control valves in real time in response to process conditions. An example would be upstream natural gas well production facilities, usually found in remote areas, where gas production from gas wells is controlled by varying the opening and closing of a control valve in the gas production line downstream of the producing well. Automatic operation of the control valve would be through the use of the electro-pneumatic diaphragm actuator or electric motor actuator attached to the valve, as described above.

Installation of an electro-pneumatic diaphragm actuator would require the use of a solar power system with backup batteries to operate the pressure regulator and the use of locally available gas (i.e. nitrogen bottles or natural gas) to operate the diaphragm for control valve operations. The solar power system installation is costly requiring, for example, at least a 40 Watt solar panel and 50 Amp-hour backup battery to generate the 3.6 Watt load. The gas supply is prohibitively expensive if bottled nitrogen is used. Alternatively, natural gas may be used to actuate the valve, which is less expensive but wasteful and environmentally unsound if much of the natural gas is used and vented to the atmosphere, as is often the case.

Installation of an electric motor actuator would require an even larger solar power system with larger backup batteries to operate the motorized choke valve. The solar power system installation is costly, and for example, may require a 120 Watt solar panel and 150 Amp-hour backup battery for intermittent operations. A system approximately twice the size may be required for continuous operations.

Some upstream natural gas production systems rely on solenoid activated “on-off” control with motorized choke valves to eliminate problems associated with electro-pneumatic diaphragm actuators and/or to minimize the size of the solar power system. Because of the lack of instrument air and AC or DC power supplies on site, most wells are operated with these “on-off” solenoid valves managed by timers to fully open and fully close motorized choke valves, providing only a general level of process control because the choke valve is either fully open or fully closed. Thus, while this set up does not require a pneumatic gas supply and utilizes the minimum amount of power for low-level control, the granularity of control of these “on-off” choke valves is limited because of their binary nature.

There is a need for a valve actuated system that allows control of the primary valve that does not require expensive and inconvenient electricity supply, or that wastefully vents natural gas to the atmosphere,and that may allow more fine tuning of the production process.

### SUMMARY OF THE INVENTION

The invention is a gas valve system that utilizes relatively small amounts of gas and electricity to actuate the primary valve as directed by the PLC or RTU. The invention includes a method and system to pulse a pair of solenoid valves to precisely regulate the volume of instrument air or other gas (e.g. nitrogen or natural gas) to the supply side or from the discharge side of a diaphragm actuator. The diaphragm actuator operates a primary variable flow/choke control valve in response to process control signals. One solenoid is on the supply (inlet) side of the primary choke control valve, and one solenoid is on the discharge (outlet) side of the primary choke control valve. The system can be used to fully close or fully open the primary variable flow/choke control valve, as well as modulate intermediate flow rates of a process fluid through the primary variable flow/choke control valve. Using electrical pulse signals to control the set of solenoid valves consumes relatively small quantities of electrical power, and controlling the pneumatic diaphragm actuator by varying gas volumes in a intermittently open system consumes minute quantities of instrument air or gas supply compared to systems of the current art. Accordingly, the gas supply vented to the atmosphere is relatively small compared to other systems.

In more detail, the invention includes a gas flow control valve at a well site including a controller, a primary valve affecting the flow of the gas, an inlet valve operably associated with the primary valve, an outlet valve operably associated with the primary valve, and wherein the controller is in operable communication with each of the inlet and outlet valves, and wherein the controller pulses the inlet valve to open the primary valve and the controller pulses the outlet valve to close the primary valve. Further, a flow meter may be positioned downstream of the primary valve and is in communication with the controller, and the controller pulses the inlet and outlet valves based on feedback from the flow meter.

Additionally, the invention includes a control system for opening and closing a choke valve positioned in a gas supply line including a supply line extending from a primary gas source to a transit line, a choke valve positioned in the conduit, the choke valve having a diaphragm actuator and being operable between at least a closed position and an open position, and an input instrument gas line having an input solenoid valve in communication with a control system, and extending from a source of instrument gas to the diaphragm actuator, and an output instrument gas line having an output solenoid valve in communication with the control system, and extending from the diaphragm actuator to an exit point, and the control system having a desired flow rate for gas flowing through the supply line and controlling the flow rate by pulsing either the input solenoid or the output solenoid to maintain the desired flow rate. The primary gas source may be a well, and the transit line may be a collection conduit for transporting the primary gas to the next step in the refinement process.

The invention is suited for automation and optimization of remote field production facilities where conventional instrument air and electrical power supplies are not readily or economically available.

Furthermore, some embodiments of the invention also may include a remote flow control system comprising an RTU in communication and control of a plurality of solenoid valves, a choke valve positioned in a main supply line and including a pneumatic actuator for opening and closing the choke valve, one of the plurality of solenoid valves positioned upstream of the pneumatic actuator, one of the plurality of solenoid valves positioned downstream of the pneumatic actuator, a flow meter positioned in the main supply line downstream of the choke valve and in communication with the RTU to report the flow through the main supply line downstream of the choke valve, and wherein the plurality of solenoid valves are pulse-actuated to control the amount of gas injected into and released from the pneumatic actuator to affect opening and closing the choke valve in response to a signal from the flow meter.

Other embodiments of the present invention may include a gas flow control valve at a well site comprising a controller, a primary valve affecting the flow of the gas, an inlet valve operably associated with the primary valve, an outlet valve operably associated with the primary valve, where the controller is in operable communication with each of the inlet and outlet valves, and where the controller pulses the inlet valve to open the primary valve and the controller pulses the outlet valve to close the primary valve.

Other embodiments of the present invention may include a control system for opening and closing a choke valve positioned in a gas supply line comprising a supply line extending from a primary gas source to a transit line, a choke valve positioned in the supply line, the choke valve having a diaphragm actuator and being operable between at least a closed position and an open position, an input gas line having an input solenoid valve in communication with the control system, an output gas line having an output solenoid valve in communication with the control system, and where the control system has a desired flow rate for gas flowing through the supply line and where the flow rate is controlled by pulsing either the input solenoid or the output solenoid to maintain the desired flow rate.

Still other embodiments of the present invention may include a method of controlling a choke valve in a well, the method comprising establishing an initial position for the choke valve, determining a flow rate through the choke valve, modulating an inlet solenoid valve coupled to a diaphragm actuator of the choke valve in response to the act of determining the flow rate through the choke valve, and modulating an outlet solenoid valve coupled to the diaphragm actuator of the choke valve in response to the act of determining the flow rate through the choke valve.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 shows the valve control system of the present invention with the valve in an open position.

FIG. 2 shows the valve control system of the present invention with the valve in a closed position.

FIG. 3 shows the valve in the control system of the present invention with the vale in an intermediate position.

FIGS. 4A and 4B show a flow chart of one control logic system for actuating the valve.

### DETAILED DESCRIPTION OF EXEMPLARY EMBODIMENTS

Upstream natural gas well production facilities are typical of remote sites where effective operation of control valves is necessary to automate and optimize the production. Gas well production is typically controlled by varying the opening/closing cycle of the well by modulating a primary control valve in response to dynamically changing well and pipeline conditions. Real-time control, which requires the continuous opening, closing and modulation of control valves in response to real-time conditions and relies upon economical and reliable sources of instrument air and AC power is not usually considered. Where a primary control valve may be operated on an efficient amount of electricity and instrument gas, more gas wells may become fitted with real-time controls, thus facilitating a more efficient and sophisticated overall system for controlling, measuring, and supplying natural gas from the wells.

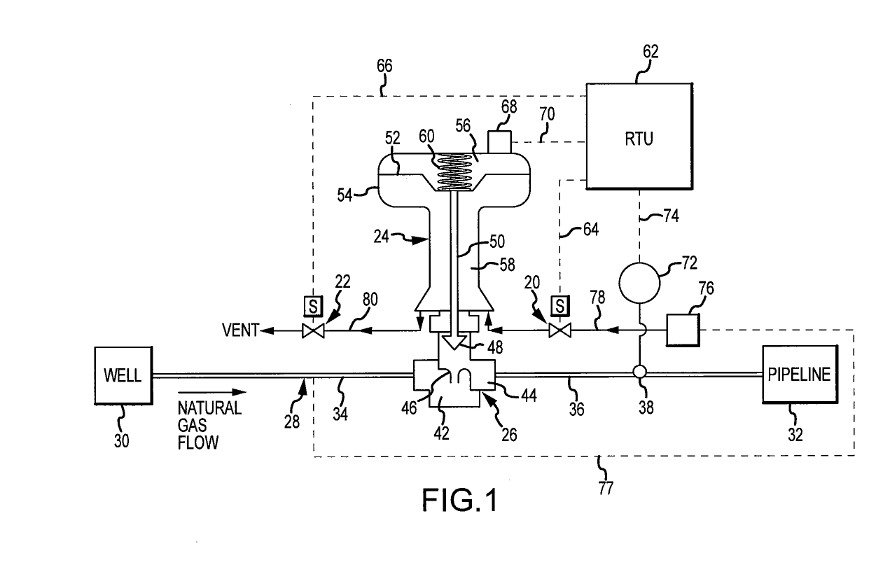

The accompanying drawings illustrate an embodiment of the present invention. FIGS. 1, 2, and 3 illustrate how saving of electrical power is achieved by momentary activation of an inlet solenoid valve 20 and an outlet solenoid valve 22 (in lieu of the current art of driving a motor) to pressurize and depressurize a diaphragm actuator 24 that drives a primary choke valve 26. This methodology of controlling the pressurization of the gas volume in the confined space of the actuator 24 limits the amount of vented gas as compared to the currently used method of maintaining continuous pressure on the actuator by the I/P device that continuously vents large volumes of gas. An I/P device is a current (hence the “I”) to pressure (hence the “P”) converter, a device that converts electrical signal, normally 4-20 ma to a 3-15 pai pneumatic signal, that in turn modulates the position of the pneumatic actuator and causes the flow rate to change.

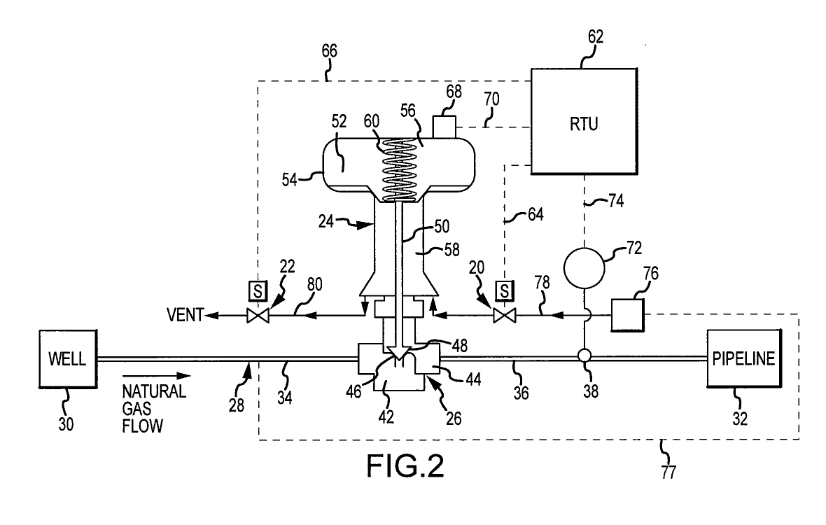

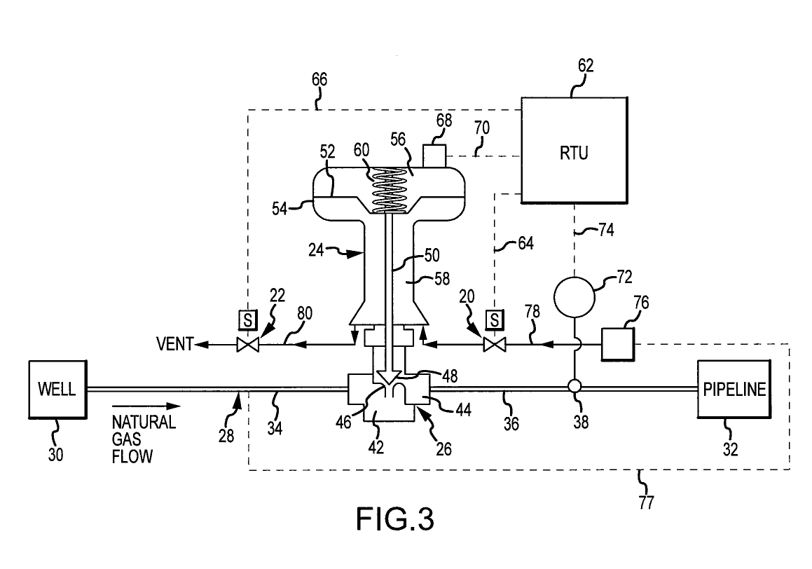

In the schematic shown in FIG. 1, which is also substantially replicated in FIGS. 2 and 3, a transport pipe 28 delivers natural gas from a natural gas well 30 to a pipeline 32. Variable choke valve 26 is positioned in the transport pipe 28 to control the flow rate of the natural gas flowing through the pipe 28. An upstream inlet section 34 is in fluid communication with the choke valve 26 and supplies gas to the choke valve 26. A downstream outlet section 36 is in fluid communication with the choke valve 26 and extends to the pipeline 32. A flow meter 38 is positioned in-line with the downstream outlet section 36, as is described in greater detail below. The primary choke valve 26 is shown schematically in FIG. 1 as having an inlet chamber 42, an outlet chamber 44, and a valve seat 46. Many different types of choke valves, whether variable or not, may be utilized in this invention.

A plunger 48 is positioned in the outlet chamber 44, and is movable relative to the valve seat 46. FIG. 1 shows the plunger 48 spaced away from the valve seat 46 to create a full-flow condition. FIG. 2 shows the plunger 48 in contact with the valve seat 46 to create a closed position. FIG. 3 shows the plunger 48 positioned near but not in contact with the valve seat 46 to represent a flow condition intermediate between full flow and the closed position. Again, many different types of choke valves may be used for this implementation. The plunger may be positioned in the inlet chamber 42, for instance. Other variations may also be obvious.

Continuing to refer to FIGS. 1, 2, and 3, diaphragm actuator 24 includes a linkage 50, with the plunger 48 mounted at one end, and a diaphragm 52 mounted at the other end. The linkage 50, plunger 48 and diaphragm 52 are movable relative to the housing 54 of the diaphragm actuator 24. The diaphragm 52 forms a seal with the inner wall of the housing 54 of the diaphragm actuator 24, dividing the interior into an upper cavity 56 and a lower cavity 58. A spring 60 is positioned in the upper chamber 56 between the diaphragm 52 and the wall of the diaphragm actuator housing 54, and biases the diaphragm 52 and the linkage 50 to the closed position. The plunger 48 is moved from the closed position to the open position and back (or to an intermediate position) by increasing or decreasing, respectively, the pressure in the lower cavity 58. This is explained in more detail below. Furthermore, while the embodiment shown in FIGS. 1-3 illustrates the spring 60 in the upper chamber 56, other embodiments are possible where the spring 60 is located in the lower cavity 58 and biases the diaphragm 52 and the linkage 50 to the open position. Depending upon the particular embodiment, the linkage 50 may vary. For example, in some embodiments the linkage 50 may be a rigid structure, a nail, a linear actuator, etc.

The control of the pressure in the lower chamber 58 is embodied in a control system interacting with a pneumatic system. The control system includes an RTU 62 (remote terminal unit) that may include a processor and associated software, memory, inputs, outputs, and communications protocols, among other features such as a clock, wireless or wired communication system, etc. The RTU is in electrical communication with the inlet solenoid 20 via a communication line 64, the outlet solenoid 22 via a communication line 66, a valve position indicator 68 via a communication line 70, and a flow transducer 72 (such as Foxborough INV Model 25) via a communication line 74, among other possible elements. Flow transducer 72 is in communication with the flow meter 38.

Valve position indicator 68 is in operable communication with the diaphragm actuator 24 to sense the position of the plunger 48, and thus the state of the valve (open, closed, or in between). Typically, the linkage 50 is attached to the valve position indicator 68 to visually display the position of the choke valve 26. The position indicator 68 may include a variable resistor so that analog data to indicate choke valve position feed back may be wired to the RTU 62. The position indicator 68 may also be equipped with two position switches so that the fully open and fully closed positions communicated to the RTU 62 to report the choke valve's 26 position.

The pneumatic system includes an instrument supply gas source 76, which may be supplied by a bleed line off the natural gas from the well 30 (shown as a dashed line 77 in FIGS. 1-3) and under pressure, or other sources such as tanks of nitrogen. The pneumatic system further includes the following in fluid communication: the inlet solenoid 20 on an inlet supply line 78 extending from the instrument supply gas source 76 to the chamber 58 of the diaphragm actuator 24, the diaphragm actuator 24, outlet solenoid 22 on an outlet line 80 extending from the chamber 58 of the diaphragm actuator 24 to the vent.

The pneumatic system and the control system interact via at least the solenoid valves 20, 22, flow meter 38, and position indicator 68.

The RTU 62 controls the inlet solenoid valve 20, and thus the amount of gas injected into the chamber 58 of the diaphragm actuator 24 through inlet solenoid valve 20. If sufficient gas is let into the chamber 58 by inlet solenoid valve 20, the pressure of the gas will overcome the bias force of the spring 60, and push the diaphragm 52 upwardly, moving the plunger 48 out of engagement with the seat 46, and opening the valve. Thus, the amount of gas injected into the diaphragm actuator 24 determines the distance that the linkage 50 travels or moves. This causes the choke valve 26 to open to increase the flow rates of the natural gas passing through the choke valve 26. Similarly, the RTU 62 controls the outlet solenoid valve 22, and thus the amount of gas released from the chamber 58 of the diaphragm actuator 24 through the outlet solenoid valve 22. If sufficient gas is let out of the chamber 58 by outlet solenoid valve 22, the pressure of the gas will decrease to a point where the bias force of the spring 60 will overcome the force of the gas on the diaphragm 52, and cause the plunger to move toward the valve seat 46, or contact and seal against the valve seat 46. The gas exiting the outlet solenoid valve 22 passes to the vent, where it is typically burned off, or emitted into the atmosphere. The gas exiting from the outlet solenoid valve may also be handled in other ways to reduce waste, such as by recapturing the exiting gas in a holding tank.

This operation is achieved by employing precisely timed pulse signals from the RTU 62 to the inlet solenoid valve 20 or outlet solenoid valve 22 to directly control the amount of gas volume injected into the chamber 58 of the diaphragm actuator 24. The amount of the diaphragm 52 movement is directly proportional to the volume of pressured gas injected through inlet solenoid valve 20. The diaphragm actuator 24 changes the size of the primary flow control choke valve 26 opening (here defined by the valve seat 46) that regulates the flow through the choke valve. The outlet solenoid valve 22 controlled by another relay in the RTU is used to release the gas from the diaphragm actuator 24. The ability to inject and release predetermined amounts of gas pressure into and out of the diaphragm actuator 24 allows the choke valve 26 to regulate the fluid flow across the choke valve to a desirable flow rate.

Referring to FIGS. 1, 2, and 3, inlet solenoid valve 20 is connected to the RTU's control output or relay contact, allowing the RTU 62 to control the amount of gas to be input into the diaphragm actuator 24. The amount of gas input into the diaphragm actuator 24 is directly proportional to the length of time the solenoid valve 20 is activated. Inputting sufficient gas causes the diaphragm actuator 24 to move against the bias force of the spring 60 to increase the gap between the valve seat 46 and the plunger 48 up to a maximum level, which may partially or entirely open the choke valve 26, thereby increasing the fluid flow through choke valve 26.

Also, outlet solenoid valve 22 is connected to the RTU's control output or relay contact, allowing the RTU 62 to control the amount of gas to be released from the diaphragm actuator 24. The amount of gas released is directly proportional to the length of time the solenoid valve 22 is activated. Releasing the gas causes the diaphragm actuator 24 to move under the bias force of the spring 60 to reduce the gap between the valve seat 46 and the plunger 48, which may partially or entirely close the choke valve 26, reducing or stopping the fluid flow through choke valve 26. This pneumatic and control system is referred to as a “partially closed” system, since the instrument gas supply is not continuously expelled by venting or other disposal.

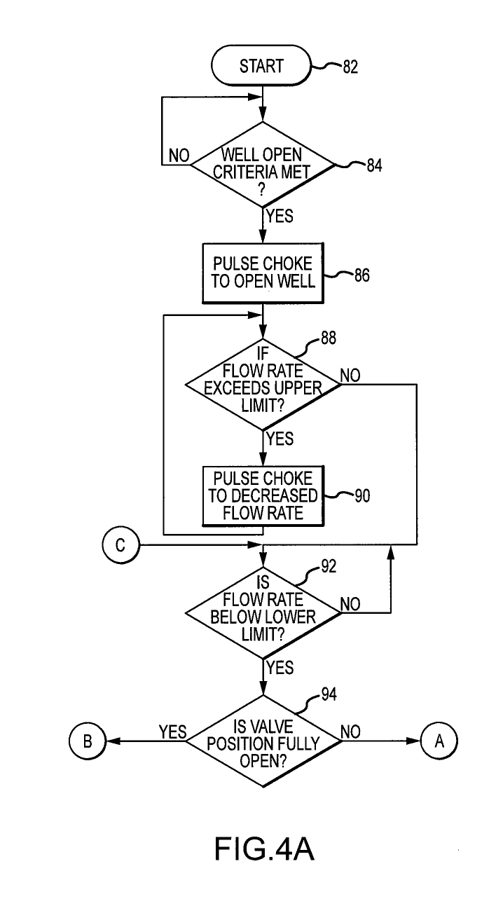

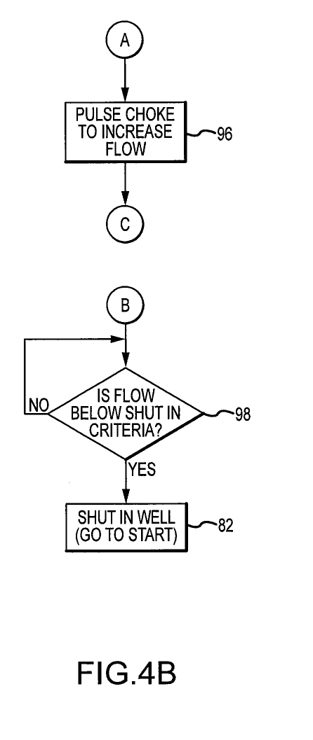

The aforementioned relays may be integrated at different points within the system. For example, in some embodiments, the relays may be integrated within the solenoid valves 20 and 22 and controlled by the RTU by applying current to the relay's coil through a transistor, that in turn causes the contact to close or open. In some embodiments, one side of the contact is hot, and the other side of the contact is wired to the solenoid valves 20 or 22. Alternatively, in other embodiments, the polarity may be reversed. Temporarily closing the contact causes the solenoid valves 20 or 22 to intermittently pulse the gas supply to operate the diaphragm actuator 24. As indicated in the flow diagram (FIG. 4), how frequent the solenoid valves 20 or 22 are pulsed is based on when the flow rate reaches the intended flow rate. Pulsing the solenoid valves 20 or 22 is caused by the RTU or other controller applying current to a relay switch on the appropriate solenoid. Other means of actuating the solenoid valves 20 or 22 may be employed with the same or similar effect. Pulsing may include a single actuation of either or both solenoid valves 20 or 22, or multiple actuations of either or both solenoid valves 20 or 22 with the same or different instructions. The pulsing action of the inlet solenoid 20 allows discrete amounts of instrument gas to be let into the lower chamber 58 to move the diaphragm 52 up (in FIGS. 1-3), such as to fully open the choke valve 26. The pulsing action of the outlet solenoid 22 allows discrete amounts of instrument gas to be let out of the lower chamber 58 to move the diaphragm 52 down, such as to fully close the choke valve 26. Multiple pulsing (either to input gas or vent gas) may be necessary to open the choke valve 26 sufficiently to obtain the target flow rate set by the RTU 62 or other controller. The desired flow rates (or other performance metric to be controlled to) may be pre-determined and stored in the RTU 62, or may be calculated by the RTU 62 based on performance of the well. The desired flow rate (or other performance metric to be controlled to) may also be received intermittently via wireless or wired communications from an outside source or manually set by a maintenance technician.

The pneumatic and control systems described herein work together to reduce the amount of energy used in actuating the primary choke valve 26. For example, the amount of current needed to drive the actuator 24 for each cycle of plunger lift operation in a liquid-loaded gas well (from choke valve fully opened to fully closed) takes about 18 seconds of 200 milli-amps current to drive the two relays (one for the inlet solenoid 20 and outlet solenoid 22) on the RTU 62, or about 0.5 milli-amp hours of current. Similarly, about 314 cubic inches or 0.2 cubic feet of gas is consumed in driving the actuator 24 to regulate the gas to flow at a desirable rate. This is based on the amount of gas needed to fill the diaphragm actuator 24 when the choke valve 26 is fully open to complete each plunger lift cycle. For a liquid-loaded gas well equipped with a plunger lift system that is cycled 8 times a day, only 4 milli-amp hours of current and 1.6 cubic feet of gas are consumed. By comparison, conventional choke valves with electrical motors have an electrical motor that consumes 1.8 amp hours of current to adjust the actuator position and more than 2 amps of current to activate the motor. Furthermore, the conventional electro-pnuematic systems require at much as 4-20 milli-amps I/P driving a pressure regulator and use both electrical current and what may be a continual stream of gas to actuate the electro-pneumatic choke valve. Thus, the embodiments of the invention disclosed here are advantageous over both conventional electric and conventional electro-pneumatic choke valves.

Referring now to FIGS. 4A and 4B, flow meter 38 is wired to RTU 62 to provide flow-rate feed back to RTU 62, so that predetermined flow-rate or band of flow-rates can be controlled by the RTU by pulsing the solenoid valves 20 and 22, as described above. The pulse period and frequency will be calculated by the RTU 62 software to minimize over shooting the targeted flow-rates. The flow rate measured by flow meter 38 is used by the RTU 62 to determine how to control the actuation of the input solenoid 20 and output solenoid 22 to control the primary choke valve. Pulsing the input solenoid 20 to open the primary choke valve 26, or pulsing the output solenoid 22 to close the primary choke valve 26, affects the position of the choke valve 26.

The flow chart shown in FIGS. 4A and 4B show one embodiment of the feedback and control system used to actuate the primary choke valve using the pneumatic and control system of the present invention. This flow chart may be operated on the RTU 62, or on another control system associated with the well 30 and/or with the RTU 62. Upon starting at block 82, a first decision is made at block 84 whether the criteria for opening the well 30 for production is met. This criteria may be based on time, certain pressures in the well, or other parameter(s). If the criteria is not met, then the analysis is made over again at block 84 until the criteria is met. On the other hand, if the criteria is met, the valve 26 is pulsed (by pulsing inlet solenoid 20 to open the valve 26) at block 86 to a pre-set initial flow rate. During this pulsing, if the flow rate does exceed the preset upper limit, as determined at block 88, then the valve is pulsed at block 90 (by actuation of outlet solenoid 22) to decrease flow rate. The new, lower flow rate is then checked at block 88 again, and if it is determined that the flow rate is not above the upper limit at block 88, the process moves to block 92, where the flow rate is determined whether or not it is below the lower limit.

The determination of block 92 repeats until the flow rate is below the lower limit. When the flow rate is below the lower limit at block 92, a determination is made at block 94 to determine if the choke valve is fully open. If the choke valve 26 is not fully open, then the process pulses the choke at block 96 (shown in FIG. 4B) so as to increase flow rate (by pulsing the inlet solenoid 20), and returns to block 92 to measure the flow rate. If at block 94 the valve 26 position is fully open, then a decision is made at block 98 (shown in FIG. 4B) as to whether the flow rate is below the shut in criteria. The shut in criteria is typically part of the control algorithm in the RTU 62 that relies on the low flow rate condition to determine when to shut in the flow. A well is shut in when the flow rate is falling out of the lower limit of the flow meter 38. If the flow is not below the shut in criteria at block 98, then the decision at block 98 is repeated until the flow rate is below the shut in criteria, at which point the well 30 is shut in and the process starts over at block 82. This is just one example of many processes that may be utilized to control the gas production on a well with the efficient pneumatic control system.

It is thus the purpose of this invention to achieve real-time flow control to automate and optimize production, as well as to make it more efficient, in remote field sites, using very limited electrical power and minute amounts of vented gas.

The RTU 62 is contemplated to be any of a variety of programmable logic controllers. The position indicator 68 may be electronic, and may provide digital output signals. The flow meter 38 may be positioned elsewhere, or may measure another parameter of the natural gas product suitable for measurement and feedback to the RTU 62 for control of the choke valve 26. The choke valve 26 need not be a functional choke valve, it may be another type of valve. This type of valve control may be used on a valve that controls liquid or dry material flow outside of the oil and gas industry, such as food processing industry, refined fuel industry, or any other application where low power consumption is desired.

Although examples of this invention have been described above with a certain degree of particularity, those skilled in the art could make numerous alterations to the disclosed embodiments without departing from the spirit or scope of the invention as described in the specification, drawings and claims. All directional references (e.g. upper, lower, upward, downward, left, right, leftward, rightward, top, bottom above, below, vertical, horizontal, clockwise, and counterclockwise) are used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, these joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing form the spirit of the invention as defined in the appended claims.

What is claimed is:

1. A remote flow control system comprising:
a remote terminal unit (RTU) in communication and control of a plurality of solenoid valves;
a choke valve positioned in a main supply line and including a pneumatic actuator for opening and closing the choke valve;
one of the plurality of solenoid valves positioned upstream of the pneumatic actuator;
one of the plurality of solenoid valves positioned downstream of the pneumatic actuator;
a flow meter positioned in the main supply line downstream of the choke valve and in communication with the RTU to report the flow through the main supply line downstream of the choke valve; and
wherein the plurality of solenoid valves are pulse-actuated to control the amount of gas injected into and released from the pneumatic actuator to affect opening and closing the choke valve in response to a signal from the flow meter.

2. The system of claim 1 in which the RTU is in direct communication and control of the choke valve to affect an incremental modulation of the fluid flow rates across the choke valve.

3. The system of claim 1, wherein the RTU has the ability to monitor and trend the positions of the choke valve through an analog signal proportional to a position of the choke valve captured by a choke valve position indicator.

4. The system of claim 2, wherein an amount of gas injected into a pneumatic actuator to affect opening of choke valve is determined by an incremental time of controlling the plurality of solenoid valves by one or more programs residing in the RTU.

5. The system of claim 2, wherein an amount of gas released from the diaphragm actuator to affect closing of the choke valve is determined by an incremental time of controlling the plurality of solenoid valves by one or more programs residing in the RTU.

6. The system of claim 1, wherein the pulse-actuation of the choke valve maintains a preset constant flow rate through the main supply line.

7. The system of claim 1, wherein the pulse-actuation of the choke valve maintains a flow rate through the main supply line that is within a preset range.

8. A gas flow control valve at a well site comprising:
a controller;
a primary valve affecting the flow of the gas;
an inlet valve operably associated with the primary valve;
an outlet valve operably associated with the primary valve;
wherein the controller is in operable communication with each of the inlet and outlet valves; and
wherein the controller pulses the inlet valve to open the primary valve and the controller pulses the outlet valve to close the primary valve.

9. The gas flow control valve of claim 8, wherein:
a flow meter is positioned downstream of the primary valve and is in communication with the controller; and
the controller pulses the inlet and outlet valves based on feedback from the flow meter.

10. The gas flow control valve of claim 9, wherein the controller pulses the inlet and outlet valve so as to maintain a preset position of the primary valve.

11. The gas flow control valve of claim 9, wherein the controller pulses the inlet and outlet valve so as to maintain a range of positions of the primary valve.

12. The gas flow control valve of claim 8, wherein the inlet valve is coupled to a main gas supply line.

13. The gas flow control valve of claim 10, wherein the controller pulses the inlet valve with gas from the main gas supply line.

14. The gas flow control valve of claim 8, wherein the controller determines a trend of a flow rate through a main supply line as a function of valve position.

15. A control system for opening and closing a choke valve positioned in a gas supply line comprising:
a supply line extending from a primary gas source to a transit line;
a choke valve positioned in the supply line, the choke valve having a diaphragm actuator and being operable between at least a closed position and an open position;
an input gas line having an input solenoid valve in communication with the control system;
an output gas line having an output solenoid valve in communication with the control system; and
wherein the control system has a desired flow rate for gas flowing through the supply line and wherein the flow rate is controlled by pulsing either the input solenoid or the output solenoid to maintain the desired flow rate.

16. The control system of claim 15, wherein the input gas line is coupled between a source of gas and the input solenoid valve.

17. The control system of claim 16, wherein the source of gas is supply line.

18. The control system of claim 16, wherein the source of gas is instrument air.

19. The control system of claim 15, wherein the output gas line is coupled between an exit point and the output solenoid valve.

20. The control system of claim 19, wherein the exit point is the atmosphere.

21. The control system of claim 20, wherein the exit point is a holding tank.

22. The control system of claim 15, further comprising an RTU operable to determine a trend of the desired flow rate versus the act of pulsing either the input or output solenoid.

23. A method of controlling a choke valve in a well, the method comprising the acts of:
establishing an initial position for the choke valve;
determining a flow rate through the choke valve;
modulating an inlet solenoid valve coupled to a diaphragm actuator of the choke valve in response to the act of determining the flow rate through the choke valve; and
modulating an outlet solenoid valve coupled to the diaphragm actuator of the choke valve in response to the act of determining the flow rate through the choke valve.

24. The method of claim 23, further comprising the act of pulsing the outlet solenoid valve in the event that the flow rate through the choke valve exceeds a preset limit.

25. The method of claim 23, further comprising the act of pulsing the inlet solenoid valve in the event that the flow rate through the choke valve is less than a preset limit.

26. The method of claim 24, further comprising the act of venting a gas flowing through the outlet solenoid valve to the atmosphere in the event that the flow rate through the choke valve exceeds a preset limit.

27. The method of claim 24, further comprising the act of venting a gas flowing through the outlet solenoid valve to a holding tank in the event that the flow rate through the choke valve exceeds a preset limit.

28. The method of claim 25, further comprising the act of providing a source of gas for the act of pulsing the inlet solenoid valve.

29. The method of claim 28, wherein the source of gas provided is the well.

30. The method of claim 28, wherein the source of gas provided is instrument air.

31. The method of claim 23, further comprising the act of determining if a shut in criteria for the well has been reached.

32. The method of claim 31, further comprising modulating the inlet and outlet solenoid valves concurrently to cause substantially no flow through the choke valve.

33. The method of claim 23, wherein the act of establishing an initial position for the choke valve further comprises the act of modulating the inlet and outlet solenoid valves concurrently.

34. The method of claim 23, wherein prior to the act of establishing an initial position for the choke valve, the method further comprises the act of determining whether an opening criteria for a well has been met.
